(19) United States
(12) Patent Application Publication
(10) Pub. No.: US 2010/0285604 A1
(43) Pub. Date: Nov. 11, 2010

(54) DISSOLVABLE FILM WITH DETECTION FUNTIONALITY

(76) Inventors: Kathleen Ann Jurman, High Bridge, NJ (US); Molly I-Chin Busby, Midland, MI (US); Darlene M. Back, Richmond, VA (US); Robert L. Schmitt, Annadale, NJ (US); Michael Minh Luong, Edison, NJ (US)

Correspondence Address: The Dow Chemical Company, P.O. BOX 1967, Midland, MI, 48641, US

(21) Appl. No.: 12/665,481

(22) PCT Filed: Jun. 30, 2008
(86) PCT No.: PCT/US08/68732

§ 371 Date: Jul. 19, 2010

Related U.S. Application Data
(60) Provisional application No. 60/948,009, filed on Jul. 5, 2007.

(51) Int. Cl. G01N 31/22; G01N 21/00

(52) U.S. Cl. 436/163; 436/164

(57) ABSTRACT

Provided are films having a visual cue agent present in a sufficient amount to present a visual cue when the film is contacted by an aqueous solution, and methods of detecting when a film is contacted by an aqueous solution.

### BACKGROUND

Films offer a convenient platform for delivering perfumes and/or cleaning compositions, including those for laundry, dishwashing, toilets, various surfaces, or other cleaning applications. These film products also enable combination of ingredients which would normally be incompatible in a liquid preparation.

Dissolvable films are designed to quickly dissolve upon contact with aqueous solutions provided by the end user. Given the film's proclivity for dissolution, and in some formulations, moisture take-up from the ambient environment, care is taken during manufacture and packaging to guard such films from contact with aqueous solutions and prolonged exposure to air. However, recognition of a compromised film is not always straightforward. For example, a film can be contaminated with an amount of aqueous solution insufficient to dissolve the film, but sufficient to decrease film performance. Decreased performance may result from, for example, unintentionally activating water labile components, such as peroxide precursors or activators, or comprising film integrity, such as creating tackiness that will interfere with subsequent packaging. It is an important goal for manufacturers to keep product performance at its best. Thus, what is needed is a dissolvable film that has incorporated safeguards to allow easy detection of contact with aqueous solutions.

Additionally, consumer cleaning or fragrance perceptions are very important in determining brand loyalty. Thus, a film that can augment the perception of cleaning or otherwise being effective will enhance a consumer's experience.

### SUMMARY

In one embodiment, the present invention provides a film having a visual cue agent present in a sufficient amount to present a visual cue when the film is contacted by an aqueous solution.

In another embodiment, the present invention provides a film, wherein the film displays a color change and effervescence when the film is contacted by an aqueous solution.

In yet another embodiment, the present invention provides a method of detecting when a film is contacted by an aqueous solution, comprising providing a visual cue agent in the film present in a sufficient amount to present a visual cue when the film is contacted by an aqueous solution.

### DETAILED DESCRIPTION

In one embodiment, the present invention provides a film having a visual cue agent present in a sufficient amount to present a visual cue when the film is contacted by an aqueous solution.

The term “visual cue” refers to a change that can be detected by the human eye, either alone, or with the aid of an energy source, such as black light. Two examples of visual cues include color change and effervescence. According, in one embodiment, the present films include a visual cue agent that presents color change or effervescence. Also, more than one visual cue may be displayed by a film, for example, in one embodiment, a plurality of visual cue agents are present, and the film displays color change and effervescence when contacted by an aqueous solution.

Visual cue agents that produce color change include pH indicators, photoactive pigments, thermochromatic pigments, and suppressed pigments (those that are revealed only after the dominant pigment disperses or is otherwise removed).

In one embodiment, the visual cue indicator is a pH sensitive color changing component. Examples of such components include those listed in Table 1.

TABLE 1

| Indicator | pH range | Color in acid | Color in base |
|---|---|---|---|
| Pentamethoxy red | 1.2-2.3 | red-violet | colorless |
| Thymol blue (1^{st}) | 1.2-2.8 | red | yellow |
| Tropeolin OO | 1.3-3.2 | red | yellow |
| 2,4-Dinitrophenol | 2.4-4.0 | colorless | yellow |
| Methyl yellow | 2.9-4.0 | red | yellow |
| Tetrabromphenol blue | 3.0-4.6 | yellow | blue |
| Bromophenol blue | 3.0-4.6 | yellow | blue-violet |
| Congo red | 3.0-5.0 | blue-violet | red |
| Methyl orange | 3.1-4.4 | red | yellow-orange |
| p-Ethoxychrysoidine | 3.5-5.5 | red | yellow |
| α-Naphthyl red | 3.7-5.0 | red | yellow |
| Alizarin sodium sulfonate | 3.7-5.2 | yellow | violet |
| Bromocresol green | 3.8-5.6 | yellow | blue-green |
| Methyl red | 4.4-6.2 | red | yellow |
| Azolitmin | 4.5-8.3 | red | blue |
| Bromocresol purple | 5.2-6.8 | yellow | purple |
| Chlorphenol red | 5.4-6.8 | yellow | red |
| Bromothymol blue | 6.0-7.6 | yellow | blue |
| Neutral red | 6.8-8.0 | red | yellow |
| Phenol red | 6.8-8.4 | yellow | red |
| Cresol Red | 7.2-8.8 | yellow | reddish-purple |
| Naphtholphthalein | 7.3-8.7 | colorless to | greenish to blue |
| | | reddish | |
| Thymol blue (2^{nd}) | 8.0-9.6 | yellow | blue |
| Phenolphthalein | 8.2-10.0 | colorless | reddish-purple |
| Thymolphthalein | 9.3-10.5 | colorless | blue |
| Alizarine Yellow R | 10.2-12.0 | yellow | red |

In one embodiment, the film changes from red to blue, red to yellow, yellow to blue yellow to red, yellow to green, blue to red, from colorless to a color, or from a color to colorless.

In one embodiment, the color change agent is bromocresol green.

The amount of visual cue agent necessary to produce a color change in a film varies with the agent, but is readily determinable. In one embodiment where the visual cue agent is a pH sensitive component, the visual cue agent is present in an amount from about 0.01% to about 0.5% by weight of the film.

In another embodiment, the color change is effected by dissolving various layers to expose the color change agent to the environment.

In films where pH indicators are the sole visual cue agents, the film may comprise at least 5% water by weight of the film.

Visual cue agents that produce effervescence include a gas emitting salt in the presence of an acid. The gas emitting salts include alkali metal and alkaline earth metal carbonates and bicarbonates, in particular sodium and potassium carbonates and bicarbonates, and magnesium and calcium carbonates. Preferably, the gas emitting salt is sodium bicarbonate. The acids include ascorbic acid, malic acid, citric acid, tartaric acid, or mixtures thereof. Preferably, the acid is citric acid.

Peroxide systems, including perborates and percarbonates, are also contemplated as visual cue agents that produce effervescence. Indeed, any combination of materials which are film compatible and can release small bubbles of gas upon contact of the film with aqueous solutions are contemplated.

The amount of visual cue agent necessary to produce effervescence in a film varies with the agent, but is readily determinable. In one embodiment, the visual cue agent to produce effervescence is present in an amount from about 1% to about 80% by weight of the film. In one embodiment, the visual cue agent is present in an amount from about 10% to about 70% by weight of the film. In one embodiment, the visual cue agent is present in an amount from about 20% to about 65% by weight of the film. In one embodiment, the visual cue agent is present in an amount from about 40% to about 65% by weight of the film. In one embodiment, the visual cue agent is present in an amount from about 50% to about 60% by weight of the film. It is understood that the effervescent films are formed from a water-free film forming composition.

In addition to a visual cue agent, films of the present invention comprise a polymer and at least one of a fragrance, surfactant, cleaning solvent, chelant, builder, foam booster, abrasive, hydrotrope, acid, alkali agent, buffer, functional polymer, ionic strength additive, anti-redeposition agent, antimicrobial, or biocide. In one embodiment, the film is a cleaning formulation suitable for household use. In one embodiment, the film is a cleaning formulation suitable for institutional and industrial use. In one embodiment, the film is a fragrance delivery film, such as an aromatherapy film. In all embodiments, the film is not ingestible.

In one embodiment, the polymer is a cellulose ether based polymer. Cellulose ether based polymers include methylcellulose, hydroxypropyl methylcellulose (for example, that sold under the tradename METHOCEL from The Dow Chemical Company), ethylcellulose (for example, that sold under the tradename ETHOCEL from The Dow Chemical Company), hydroxyethyl cellulose (for example, that sold under the tradename CELLOSIZE from The Dow Chemical Company), cationic hydroxyethyl cellulose (for example, that sold under the tradenames CELLOCAT and UCARE from The Dow Chemical Company), hydrophobically modified hydroxyethyl cellulose (for example, that sold under the tradename CELLOSIZE HMHEC from The Dow Chemical Company), and cationic hydrophobically modified hydroxyethyl cellulose (for example, that sold under the tradenames CELLOCAT and SOFTCAT from The Dow Chemical Company).

Molecular weight has a determinable effect on speed of dissolution. Suitable cellulose ether based polymers have a weight average molecular weight of about 15,000 to about 5,880,000. Of course, the degree of alkyl-aryl substitution varies by class of cellulose ether based polymers. In one embodiment, cellulose ether based polymer is present in an amount from about 15% to about 70% by weight of the film.

In one embodiment, the cellulose ether based polymer includes at least one of methylcellulose or hydroxypropyl methylcellulose. In this embodiment, the polymer comprises at least 19% by weight of the film. Within this embodiment, the polymer may comprise at least 30% by weight of the film, and preferably at least 40% by weight of the film. In some embodiments, the methylcellulose or hydroxypropyl methylcellulose polymer comprises less than 70% by weight of the film, preferably less than 60% by weight of the film. In one embodiment, the methylcellulose or hydroxypropyl methylcellulose polymer is present in a range from about 19% to about 70% by weight of the film, preferably from about 30% to about 60% by weight of the film, more preferably from about 40% to about 52% by weight of the film. One particularly preferred polymer is METHOCEL hydroxypropyl methylcellulose, available from The Dow Chemical Company.

In one embodiment, the polymer is polyoxyethylene. Suitable polyoxyethylene polymers have a molecular weight of about 50,000 to about 10 MM average molecular weight. One particularly preferred polymer is POLYOX polyoxyethylene, available from The Dow Chemical Company. In one embodiment, polyoxyethylene is present in an amount from about 10% to about 70% by weight of the film. In one embodiment, polyoxyethylene is present in an amount from about 30% to about 60% by weight of the film. In one embodiment, polyoxyethylene is present in an amount from about 40% to about 50% by weight of the film.

When a film of the present invention is to be a cleaning film, the ingredients may be selected from a variety of known combinations. For example, examples of suitable formulations may be found in the Advanced Cleaning Products Formulations Database, Flick, E, (2006), William Andrew Publishing, the entirety of which is incorporated herein. The selection is dictated by the end use of the film, for example laundry, including stain removal, anti-soil redeposition, fabric softening, and the like, dishwashing, both hand and dishwasher, toilet cleaning, general surface cleaning, fabric cleaning, automotive cleaning, glass cleaning, ceramic cleaning, or wood cleaning.

In some embodiments, the cleaner comprises a surfactant and a solvent. The surfactant may be an anionic surfactant, a nonionic surfactant, or a cationic surfactant. Anionic surfactants include sodium laurate, sodium myristate, sodium palmitate, and sodium stearate. A preferred anionic surfactant is DOWFAX anionic surfactant, available from The Dow Chemical Company.

Nonionic surfactants include polyoxyethylenealkylethers, polyoxyethylenealkylphenylethers, polyoxyethylenepolystyrylphenylether, polyoxyethylenepolyoxypropyleneglycol, polyoxyethylenepolyoxypropylenealkylethers, polyhydric alcohol fatty acid partial esters, polyoxyethylenepolyhydric alcohol fatty acid partial esters, polyoxyethylene fatty acid esters, polyglycerin fatty acid esters, polyoxyethylenized caster oil, fatty acid diethanolamide, polyoxyethylenealkylamines, triethanolamine fatty acid partial esters, and trialkylamine oxides. A preferred nonionic surfactant is TERGITOL nonionic surfactant, available from The Dow Chemical Company.

Cationic surfactants include quaternary ammonium salts such as primary-tertiary aliphatic amine salts, tetraalkyl ammonium salts, trialkylbenzyl ammonium salts, alkylpyridinium salts, 2-alkyl-1-alkyl-1-hydroxyethylimidazolinium salts, N,N-dialkylmorpholinium salts, polyethylenepolyamine aliphatic amide salts, salts of urea condensates of polyethylenepolyamine aliphatic amides, and quaternary ammonium salts of urea condensates of polyethylenepolyamine aliphatic amides.

Other examples of surfactants include N,N-dimethyl-N-alkyl-N-carboxymethylammonium betaines, N,N-dialkylaminoalkylene carboxylates, N,N,N-trialkyl-N-sulfoalkyleneammonium betaines, N,N-dialkyl-N,N-bispolyoxyethyleneammonium sulfate betaines, and 2-alkyl-1-carboxymethyl-1-hydroxyethylimidazolinium betaines.

In one embodiment, the surfactant is present in an amount from about 5% to about 70% by weight of the film depending on the use. It is understood that blends of surfactants, and cosurfactants, are contemplated as well.

The solvent is one typically used in cleaning applications. In one embodiment, the solvent is a low odor glycol ether. A preferred low odor glycol ether is DOWANOL PnB propylene n-butanol glycol ether, available from The Dow Chemical Company. In another embodiment, the solvent is a terpene, for example limonene or pine oil. In yet another embodiment, the solvent is a relatively higher molecular weight alcohol, such as C5 and above.

In one embodiment, the solvent is present in an amount from about 5% to about 70% by weight of the film. In one embodiment, the solvent is present in an amount from about 10% to about 50% by weight of the film. In one embodiment, the solvent is present in an amount from about 20% to about 30% by weight of the film. It is understood that blends of solvents, where compatible, and cosolvents, are contemplated as well.

In one embodiment, the film comprises at least 20% by weight of the film of a cellulose ether based polymer, a cleaner comprising a surfactant and a low odor glycol ether, and a visual cue agent present in a sufficient amount to present a visual cue when the film is contacted by an aqueous solution.

It is understood that films of the present invention may further comprise additional components, including perfumes, builders, foam boosters, chelants, zeolites, water softeners, alkali agents, neutral salts, anti-redeposition agents, and biocides. It is also understood that certain components may appear in more than one category, and that the following lists are exemplary and other conventional additives may be included.

Perfumes include any component which provides a pleasant scent, either to the film itself, or upon dissolution. Perfumes are generally aldehydes or ketones, and often oils obtained by extraction of natural substances or synthetically produced. Perfumes can be accompanied by auxiliary materials, such as fixatives, extenders, stabilizers and solvents. Without being bound by theory, it is observed that perfumes that have been incorporated in films of the present invention demonstrate surprising bloom. In one embodiment, the perfume is present in an amount from about 0.05% to about 5% by weight of the film.

Builders include alkali or earth alkali metal salts of phosphoric acid (for example, alkali metal tripolyphosphates, sodium pyrophosphate, potassium pyrophosphate, ammonium pyrophosphate, sodium orthophosphate, potassium orthophosphate, sodium polymetaphosphate; and phytic acid salts, or mixtures thereof), polycarboxylates, polycarboxylic acids, lactates, citrates, borates, phosphates, and mixtures thereof. Examples of chelants include organic phosphonates such as the amino alkylene poly (alkylene phosphonates), alkali metal ethane 1-hydroxy disphosphonates, and nitrilo trimethylene phosphonates. In one embodiment, the chelant is diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA; VERSENOL 120), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), or mixtures thereof. Water softeners include sodium ethylenediaminetetraacetate (EDTA), sodium nitrilotriacetate (NTA), sodium citrate, or sodium tripolyphosphate.

The builders can be present in an amount from about 0.01% to about 50% by weight of the film.

Foam boosters include amine oxides (including alkyl amine oxides and ethoxylated amine oxides), betaines, sultaines and alkanolamides. In one embodiment, the foam boosters are present in an amount from about 0.01% to about 20% by weight of the film.

Alkali agents include sodium polyphosphates such as sodium tripolyphosphate, sodium silicate, sodium carbonate, or sodium borate.

Neutral salts include Glauber's salt or magnesium chloride.

Anti-redeposition agents include carboxymethylcellulose and other water-soluble polymers.

Biocides include antimicrobials, bactericides, fungicides, algaecides, mildicides, disinfectants, antiseptics, and insecticides.

In some embodiments, the film further comprises additional polymers, including at least one of starch, gelatin, polyacrylimide, or pullan. In one embodiment, the additional polymers are present in an amount from about 0.01% to about 40% by weight of the film.

In another embodiment, the present invention provides a method of detecting when a film is contacted by an aqueous solution, comprising providing a visual cue agent in the film present in a sufficient amount to present a visual cue when the film is contacted by an aqueous solution.

In another embodiment, a cleaning film is provided, wherein the film displays a color change and effervescence when the film is contacted by an aqueous solution.

In an alternative embodiment of the present invention, a perfume film is provided, comprising a polymer, comprising at least one of a) a cellulose ether based polymer, provided that when the cellulose ether based polymer is methylcellulose, hydroxypropyl methylcellulose, or a blend thereof, the cellulose ether based polymer comprises at least 19% by weight of the film, or b) a polyoxyethylene polymer, and a visual cue agent present in a sufficient amount to present a visual cue when the film is contacted by an aqueous solution. In one embodiment, the perfume film is useful for aromatherapy.

Films of the present invention can be prepared by any conventional method, for example, thermal processing (e.g., extrusion, melt-mixing, and plaquing) and solvent based methods, for example, solvent casting.

### EXAMPLES

The following examples are for illustrative purposes only and are not intended to limit the scope of the present invention. All percentages are by weight unless otherwise specified.

### Example 1

Exemplary water free formulated films contain the components in TABLE 2.

TABLE 2
Final Film (Dry Weight)

| | Smp. 1 | Smp. 2 | Smp. 3 | Smp. 4 | Smp. 5 | Smp. 6 | Smp. 7 |
|---|---|---|---|---|---|---|---|
| Component | Wt. % | Wt. % | Wt. % | Wt. % | Wt. % | Wt. % | Wt % |
| METHOCEL E15LV | 19 | 40 | 19 | — | — | — | — |
| hydroxypropyl | | | | | | | |
| methylcellulose | | | | | | | |
| Polyox WSRN-N10 | — | — | — | 48 | — | — | — |
| Polyoxyethylene | | | | | | | |
| HMHEC 500. | — | — | — | — | 19 | — | — |
| Hydrophobically | | | | | | | |
| modified hydroxy | | | | | | | |
| ethylcellulose | | | | | | | |
| SL-K-SoftCAT | — | — | — | — | — | 19 | — |
| Hydrophobically | | | | | | | |
| modified cationic | | | | | | | |
| hydroxyethylcellulose | | | | | | | |
| LR400-UCARE or | — | — | — | — | — | — | 19 |
| CelloCAT Cationic | | | | | | | |
| hydroxyethylcellulose | | | | | | | |
| Citric Acid | 29 | 28 | 29 | 30 | 29 | 29 | 29 |
| Bicarbonate | 26 | 24 | 26 | 18 | 25 | 25 | 25 |
| TRITON CG-110 alkyl | 23 | — | 23 | — | 22 | 22 | 22 |
| polyglucoside non-ionic | | | | | | | |
| surfactant | | | | | | | |
| MONAMID (716 lauric | 3 | 8 | 3 | 4 | 5 | 5 | 5 |
| acid diethanolamide; | | | | | | | |
| Uniqema) foam booster | | | | | | | |
| Citrus Oil Fragrance | <0.5 | <0.5 | <0.5 | <0.5 | — | — | — |

Films may be prepared by the following protocol. As the fizzing (visual cue) agent is activated by water, a solvent base procedure is used to prepare the formulations. Water free surfactants are also used. The polymer is first dissolved in appropriate solvent. For example, POLYOX can be dissolved in acetonitrile at room temperature, whereas METHOCEL is heated in DMF (dimethyl formamide) while stiffing at 85° C. or higher until dissolved. Cationic HEC and Hydrophobic modified HEC can be dissolved in DMSO (dimethyl sulfoxide) at room temperature. Typical solution concentrations are about 18% POLYOX in Acetonitrile, about 6.2% METHOCEL in DMF, and about 1-2% cationic HEC in DMSO.

Sample 2 and 4 are inventive films, but are designed for aromatherapy or other surfactant-less perfume release needs.

Following the polymer dissolution, the remaining steps are performed at room temperature. A mechanical impeller is used to stir the solution.

Citric acid is added to the polymer solution while stirring. In the case of METHOCEL, the heating is turned off during the citric acid addition. Citric acid is added slowly to the polymer solution to avoid lumping, and the mixture is stirred until dissolution is complete. Alternatively, citric acid could first be added to the solvent followed by polymer addition.

The other components (e.g. surfactants, plasticizer, foam booster, perfume) can be added and mixed thoroughly. Citrus oil fragrance is added using small disposable glass pipette.

The sodium bicarbonate then is added and stirred to obtain homogeneous dispersion. The sodium bicarbonate should not dissolve, as the solvent is pre-selected to avoid activation.

For color changing (visual cue) films, a pH indicator, for example, bromocresol green indicator is added incrementally and sparingly to color the film (i.e., roughly 5-50 mg bromocresol green powder added directly to the film forming solution). A film substantially similar to Sample 3 was made with color change as a second visual cue.

The stirrer is turned off and the slurry is allowed to sit static to allow the bubbles entrapped in the solution to migrate out. The bicarbonate will remain suspended for most solutions, but if it settles, gentle stirring before casting the film will re-suspend the bicarbonate.

The slurry is solvent cast into films, for example, using a 40 mil gap on a square film caster. Optionally, the visual cue effect is enhanced by sprinkling solid sodium bicarbonate-citric acidic particles on the surface of the solvent cast films, while the film is still wet. To prepare particles, the citric acid and sodium bicarbonate can be ground and seived through a #35 US mesh screen. A 1:2 molar ratio of citric acid (FW 192.2 g) to sodium bicarbonate (FW 84.01 g)) is used. Using a tablet press and 2000 lbs of pressure, the sieved particles can be formed into 3.5 g tablets. The tablets are then broken and sieved through a series of mesh # 10, #14, #20, #35 to obtain particles of different sizes. These particles are sprinkled onto the films before they are completely dried to serve as extra fizzing agent.

The films are allowed to dry overnight.

### Example 2

Another exemplary film could contain the components recited in TABLE 3.

TABLE 3
Final Film (Dry weight)

| | Percent by |
|---|---|
| Component | weight of film |
| METHOCEL E15LV hydroxypropyl methylcellulose | 51 |
| DOWFAX A1 anionic surfactant | 17 |
| DOWANOL PnB propylene n-butanol glycol ether | 26 |
| Bromocresol green | Amt. sufficient to |
| | color the film |
| Residual Water | Balance (~6%) |

Example 2 differs from Example 1 in that the preparation and final film contain water. Preparation of Example 2 differs preparation of Example 1 in that 20 g of polymer is initially suspended via slurry in 60 g of isopropyl alcohol. Next, 10 g of glycol ether solvent is added and sufficient grams of color indicator is added to color the solution (<0.1 g). Finally 40 g of water is added to 15 g of the anionic surfactant solution (40% actives in a water solution) and the combination is added to the preparation. The solution is solvent cast onto glass plates and dried overnight, but any conventional casting method can be used.

### Example 3

Another exemplary surfactant based film could contain the components recited in TABLE 4.

TABLE 4
Final Film (Dry weight)

| | Percent by |
|---|---|
| Component | weight of film |
| METHOCEL E15LV hydroxypropyl methylcellulose | 51. |
| TERGITOL 5-S-9 anionic surfactant, 100% solution | 17 |
| DOWANOL PnB propylene n-butanol glycol ether | 26 |
| Bromocresol green | Amt. sufficient to |
| | color the film |
| Water | Balance (~6%) |

Preparation of this film is the same as Example 2, except 7 g of nonionic surfactant is combined with 60 g of water, and this mixture is then added to the preparation.

### Example 4

Exemplary surfactant based films contain the components recited in TABLE 5.

TABLE 5
Final Film (Dry Weight)

| | Smp. 10 | Smp. 11 | Smp. 12 | Smp. 13 |
|---|---|---|---|---|
| Component | Wt. % | Wt. % | Wt. % | Wt. % |
| METHOCEL E15LV | 4.8 | 9.8 | 3.5 | 14 |
| hydroxypropyl methylcellulose | | | | |
| 2-hydroxyethyl starch | 20.56 | 19.5 | — | — |
| Poly(vinyl alcohol) | — | — | 20.8 | — |
| Carrageenan (CP KELCO Cl-123) | — | — | — | 43 |
| Citric Acid | 28.6 | 27.1 | 29 | — |
| Bicarbonate | 25.03 | 23.8 | 25.4 | — |
| TRITON CG-110 alkyl | 20.56 | 19.5 | 20.8 | 43 |
| polyglucoside non-ionic surfactant | | | | |
| Citrus Oil Fragrance | 0.16 | 0.1 | 0.2 | — |
| Bromocresol Green | 0.29 | 0.2 | 0.3 | 0.0013 |

Use of various polymer blends can affect degree of film integrity and other performance metrics, such as dissolution rate. Polymer matrix blends of METHOCEL with other water soluble polymers are included in the present invention.

Samples 10-12 were prepared via a solvent based (water-free) technique for effervescing visual cues. PVOH or hydroxyethyl starch is first dissolved in DMSO, and MEHOCEL is next added, followed by the remaining active ingredients.

Samples with color change cues alone can be prepared via solvent based or water based formulations. In the case of Sample 13, the sample was prepared by first dissolving blends of METHOCEL and carrageenan in water, and then adding other active ingredients, including a color change agent.

All formulations formed films, however Sample 13 showed less than optimal integrity.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A film, comprising:
a polymer, comprising at least one of:
a) a cellulose ether based polymer, provided that when the cellulose ether based polymer is methylcellulose, hydroxypropyl methylcellulose, or a blend thereof, the cellulose ether based polymer comprises at least 19% by weight of the film; or
b) a polyoxyethylene polymer;
at least one of a fragrance, surfactant, cleaning solvent, chelant, builder, foam booster, hydrotrope, abrasive, acid, alkali agent, buffer, functional polymer, ionic strength additive, anti-redeposition agent, antimicrobial, or biocide; and
a visual cue agent present in a sufficient amount to present a visual cue when the film is contacted by an aqueous solution.

2. The film of claim 1, wherein the visual cue agent presents color change or effervescence.

3. The film of claim 1, wherein a plurality of visual cue agents are present, and the film displays color change and effervescence when contacted by an aqueous solution.

4. The film of claim 1, wherein the visual cue agent is a color change agent.

5. The film of claim 4, wherein the color change agent is a pH indicator, photoactive pigment, thermochromatic pigment, or suppressed pigment.

6. The film of claim 4, wherein the color change agent is bromocresol green.

7. The film of claim 4, wherein the visual cue is that the film changes from red to blue, red to yellow, yellow to blue yellow to red, yellow to green, blue to red, from colorless to a color, or from a color to colorless.

8. The film of claim 4, wherein the visual cue agent is present in an amount from about 0.01% to about 0.5% by weight of the film.

9. The film of claim 4, further comprising at least 5% water by weight of the film.

10. The film of claim 1, wherein the visual cue agent is an effervescent agent.

11. The film of claim 10, wherein the effervescent agent is a gas emitting salt in the presence of an acid, peroxide precursor, percarbonate, or perborate.

12. The film of claim 10, wherein the effervescent agent is sodium bicarbonate in the presence of citric acid.

13. The film of claim 10, wherein the visual cue agent is present in an amount from about 1% to about 80% by weight of the film.

14. The film of claim 1, wherein the polymer is cellulose ether based polymer and is at least one of methylcellulose, hydroxypropyl methylcellulose, ethylcellulose, hydroxyethyl cellulose, cationic hydroxyethyl cellulose, hydrophobically modified hydroxyethyl cellulose, or cationic hydrophobically modified hydroxyethyl cellulose.

15. The film of claim 1, wherein the polymer is cellulose ether based polymer and includes at least one of methylcellulose or hydroxypropyl methylcellulose.

16. The film of claim 1, wherein the polymer is polyoxyethylene in an amount from about 10% to about 70% by weight of the film.

17. The film of claim 1, wherein the film further comprises additional polymers, including at least one of starch, gelatin, pullan, or polyacrylimide.

18.-19. (canceled)

20. A method of detecting when a film is contacted by an aqueous solution, comprising:
providing a visual cue agent in the film present in a sufficient amount to present a visual cue when the film is contacted by an aqueous solution.

21. The film of claim 2, wherein the film is a cleaning film or an aromatherapy film.
